(19) United States
(12) Patent Application Publication
(10) Pub. No.: US 2007/0180381 A1
(43) Pub. Date: Aug. 2, 2007

(54) Browser application

(76) Inventors: Stephen James Rice, Leesburg, VA (US); Sudheer Agrawal, Ashburn, VA (US)

Correspondence Address: FISH & RICHARDSON P.C., P.O. BOX 1022, MINNEAPOLIS, MN, 55440-1022, US

(21) Appl. No.: 11/342,644

(22) Filed: Jan. 31, 2006

(51) Int. Cl. G06F 9/00

(52) U.S. Cl. 715/711; 715/862; 715/856; 715/838

(57) ABSTRACT

Techniques are described for web navigating. Web pages may be organized such that each web page is associated with a corresponding tab, and a visual tip is displayed for a web page in response to selection of the associated tab. A visual tip also may be displayed for a web page in response to selection of a navigation control associated with the web page.

### TECHNICAL FIELD

This document relates to a browser application.

### BACKGROUND

Web browsers are widely used by computer users to access and view information over the Internet. A web browser presents a user with web pages that include textual information, images, and other multimedia information. The web browser also may include a list of links to web pages that the user frequently visits, so that the user may have quick access to these web pages. The web browser also may include navigation controls for the user to go back or go forward among a list of web pages that the user has recently visited.

### SUMMARY

In one general aspect, when navigating the web, one or more web pages are accessed with each web pages associated with a tab. Each web page is presented with the associated tab in a browser window. A visual tip for a web page is displayed when a pointer hovers over a tab associated with the web page.

Implementations may include one or more of the following features. For example, the visual tip may include a text summary of the associated web page. The visual tip also may include a miniature graphical representation of the associated web page. The miniature graphical representation of the web page may be stored in a local cache or a remote storage device.

In another general aspect, when navigating the web, one or more web pages are organized with each web page being associated with a navigation control in a browser window. A visual tip is displayed for a web page when a pointer hovers over a navigation control associated with the web page.

Implementations may include one or more of the following features. For example, the navigation control may be a back button, a forward button, or a favorite list.

In another general aspect, rendering a graphical representation of a web page in a browser application includes loading a web page, generating a graphical representation of the web page, creating a visual tip using the graphical representation of the web page, storing the visual tip, associating the stored visual tip with a tab in a browser application, and displaying the visual tip in the browser application when a pointer hovers over the tab associated with the web page.

Implementations may include one or more of the following features. For example, the visual tip may be a miniature graphical representation of the web page.

Implementations of any of the techniques described may include a method or process, an apparatus or system, or computer software on a computer-accessible medium. The details of particular implementations are set forth below. Other features will be apparent from the description and drawings, and from the claims.

### DESCRIPTION OF DRAWINGS

FIG. 1A is an exemplary screen shot of an enhanced browser showing a visual tip of a web page in the format of a miniature graphical representation.

FIG. 1B is an exemplary screen shot of the web page that is associated with the visual tip of FIG. 1A loaded in the enhanced browser.

FIG. 2 is an exemplary screen shot of the enhanced browser showing a visual tip of a web page in the format of a text summary of the web page.

FIG. 3 is an exemplary screen shot of the enhanced browser showing a visual tip when a back button is hovered over.

FIG. 4 is an exemplary screen shot of the enhanced browser showing a visual tip when a forward button is hovered over.

FIG. 5 is an exemplary screen shot of the enhanced browser showing a visual tip when an entry in the favorite link list is hovered over.

FIG. 6 is an exemplary flowchart illustrating a process of creating, storing and retrieving visual tips from an enhanced browser

Like reference symbols in the various drawings may indicate like elements.

### DETAILED DESCRIPTION

An enhanced browser application (“browser”) organizes a list of links to web pages in the format of tabs. When hovering over a tab, for example, with a pointer, the browser displays a visual tip as to the content of the web page associated with the tab, without requiring the user to actually load the web page. Hovering may be of any form of implicit selection, e.g., the pointer stays still for a short period of 0.3 seconds. Alternatively, hovering may be of any form of an explicit selection, e.g., a right mouse button click or a left mouse button click.

The visual tip may include, for example, a miniature graphical representation of the web page or a text summary of the content of the web page. A visual tip also may be displayed when the user points to navigation controls, such as, for example, the back and forward buttons on the browser (with, for example, a visual tip as to the content of a web page that would be accessed when the back button is selected being displayed when the user points to the back button). Additionally or alternatively, a visual tip also may be displayed when the user points to other lists of links. For example, a browser may include a “favorite” list of web page links that serve as shortcuts to the web pages. When the user points to an entry on the favorite list, a visual tip may be displayed in the browser to remind the user of the web page's content or format. The visual tips serve to remind the user of the web page and/or the content of the web page at a high level, without requiring the user to actually load the web page.

The visual tip allows the user to make a quick decision as to whether to visit the web page, based on the content and/or images included in the visual tip. As a result, the user may have a much smoother browsing experience without being interrupted to load undesirable web pages.

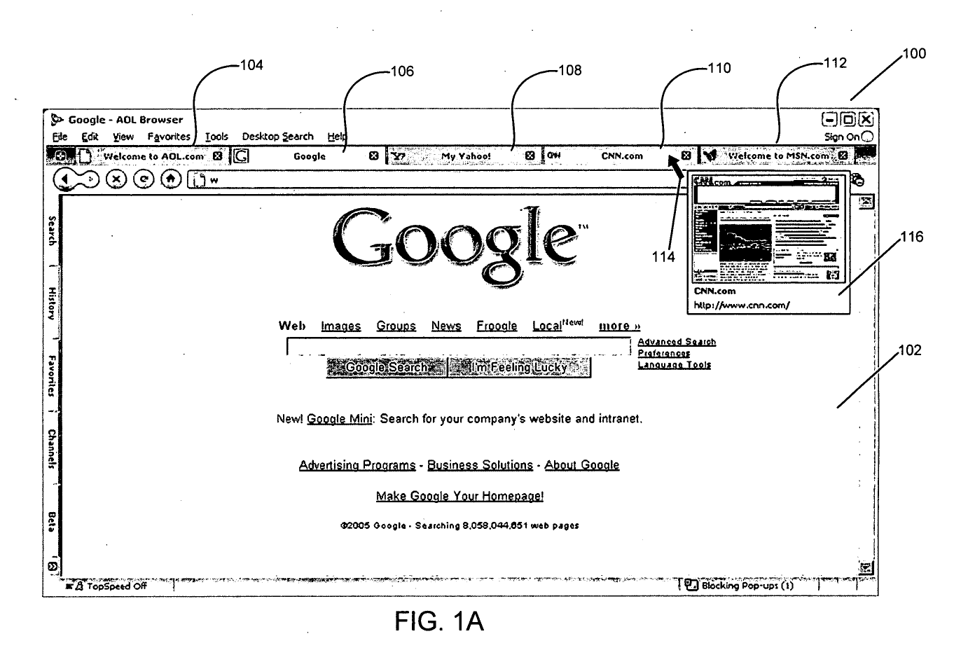

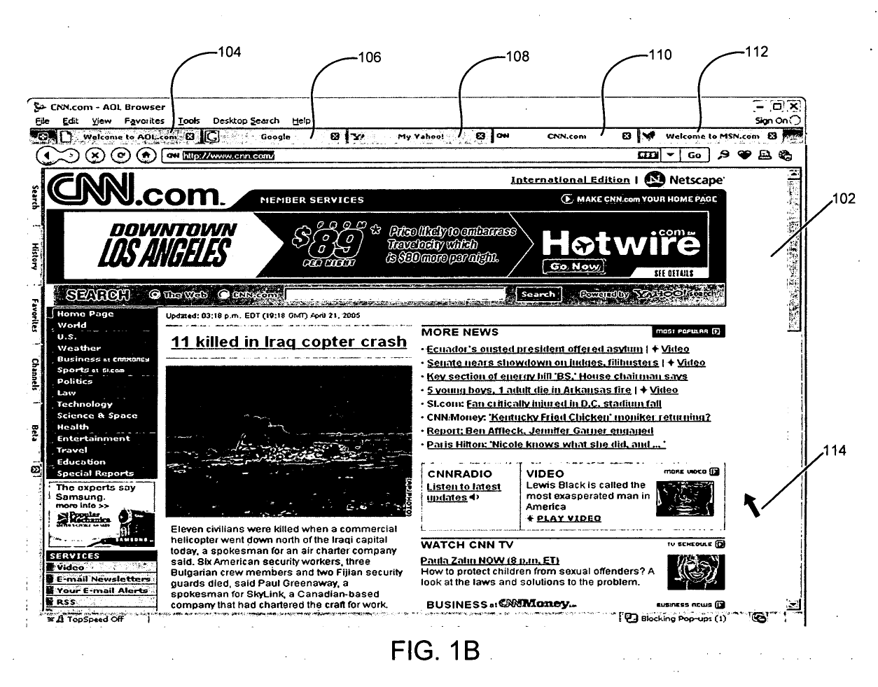

FIG. 1A is an exemplary screen shot of an enhanced browser page 100 showing a visual tip for a selected web page. The browser page 100 includes a main content window 102 that displays a web page that is currently loaded in the browser window, for example, by the browser user. In this example, the content window 102 displays a Google™ search page. The browser page 100 also includes a list of web pages (for example, web pages that the user frequently visits) and organizes the list of web pages using tabs 104-112. Each of tabs 104-112 may represent a web page that the user previously opened. In the example shown in FIG. 1A, the tab 104 represents a link to a web page “AOL.com,” the tab 106 represents a link that is associated with a web page “Google,” the tab 108 represents a link that is associated with a web page “My Yahoo,” the tab 110 represents a link that is associated with a web page “CNN.com,” and the tab 112 represents a link that is associated with a web page “MSN.com.”

When the user selects a tab, for example, by clicking on the tab 106, the web page associated with the tab 106 loads in the content window 102 of the browser page 100. As shown, the tab 106 may be highlighted to indicate that the tab 106 is currently selected or in focus.

The browser page 100 also includes an input pointer 114 that may be moved freely on the browser page 100 and may be used as an input mechanism of the browser application. The user may move the input pointer 114 by manipulating an input device such as, for example, a mouse. In another example, the input pointer 114 may be manipulated by gesturing with a finger or a stylus on a touch pad of the browser computer. In still another example, the input pointer 114 may be moved by moving a laser pen, typing the direction keys on the keyboard, (e.g., up, down, left and right arrow keys), or by using another pointing device that is used as the input device and communicates with the browser computer.

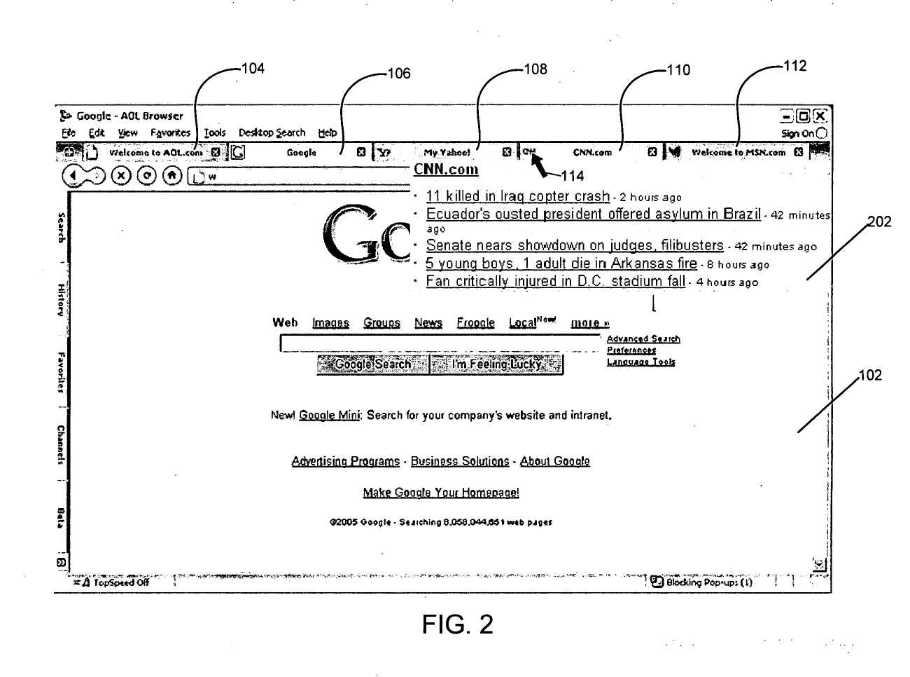

In the enhanced browser, a visual tip appears when the input pointer 114 hovers over a tab area to help the browser user to decide whether to view the web page associated with the tab. Referring to FIG. 1A, the input pointer 114 hovers over the tab 110, which is associated with the web page “CNN.com”. A visual tip 116 for the associated web page “CNN.com” displays beneath the tab 110. The user does not need to actually select on the tab 110 for the visual tip 116 to appear. Instead, the visual tip 116 is displayed when the user simply leaves the input pointer 114 over tab 110 for a sufficient amount of time (e.g., 0.3 seconds). The visual tip 116 may be, for example, in the format of a miniature graphical representation of the associated web page. The visual tip 116 also may be in a text format that provides a text overview of the associated web page, as discussed below with respect to FIG. 2. Additionally or alternatively, the visual tip 116 may include other related information, such as, for example, the title 118 or the URL 120 of the web page as shown in FIG. 1A.

The visual tip 116 provides hints that assist the user in deciding whether to load the associated web page. In one implementation, the visual tip 116 displays when the input pointer 114 hovers over the tab for a short period of time (e.g., 0.3 seconds) to indicate a potential interest in the associated web page.

The visual tip 116 may disappear, for example, when the pointer 114 moves out of the tab area 110. Similarly, when the input pointer 114 moves to and hovers over another tab (e.g., tab 108), a new visual tip associated with the tab 108 is displayed. In other words, the visual tip 116 may display dynamically following the movement of the input pointer 114 over the tabs.

In one implementation, the visual tips are rendered by the browser application (i.e., the client system). More specifically, the browser application generates the visual tips on the client system and stores the visual tips locally, such as, for example, in a local cache in the client system. For example, the client system may capture a snap shot of the web page that the user visits, resize the snap shot to generate the miniature graphical representation of the web page, and then use the miniature graphical representation in the visual tip associated with the web page.

Alternatively, the client system may obtain a text summary of the web page that the user visits and use the text summary to generate a visual tip in text format. In one specific example, the client system obtains Rich Site Summary (RSS) feed from the web page, formats the feed in a presentable manner and uses the feed in the visual tip. RSS is a XML-based summary of a web site that includes, for example, news headlines and other contents of the web site.

The client system may store the browser-generated visual tips in a local cache, and the browser application may retrieve a visual tip from the local cache. For example, when the pointer 114 hovers over a tab, the visual tip associated with the web page for that tab is retrieved from the local cache and displayed to the user. In this implementation, the visual tips are personalized to the web client, i.e., the client system. As a result, different client systems may provide different visual tips for the same web page.

In another implementation, the visual tips are rendered using a host system. The visual tips may be cached remotely in the host system, which maintains and updates the visual tips for multiple web pages, and renders an associated visual tip to a client browser when a tab associated with the web page is hovered over, or is to be pre-viewed. In this implementation, the visual tips are generated and shared by multiple client browsers that are in communication with the host system. As a result, different browsers may view the same visual tip for a web page. Further, the host system may update the visual tips such that the visual tips are near real-time representations of the web pages. Details of visual tips rendering are discussed below with respect to FIGS. 7 and 8.

FIG. 1B is an exemplary screen shot of the web page that is associated with the tab 110 of FIG. 1A. The content window 102 displays the loaded web page “CNN.com,” which is associated with the selected tab 110. The loaded web page in the content window 102 shows a consistent look with its miniature graphical representation, as shown in the visual tip 116 of FIG. 1A. As an example, the layout and the miniature images in the miniature graphical representation of the web page of the visual tip 116 give the user visual hints that remind the user of the format of a previously visited web page.

FIG. 2 is an exemplary screen shot of the enhanced browser showing a visual tip for a web page in the format of a text summary of the web page. In FIG. 2, the browsing tabs 104-112 display above the content window 102. The content window 102 displays a selected web page, as indicated by the highlighted tab 106. The pointer 114 hovers over the tab 110, which is associated with the web page “CNN.com.” A visual tip 202 for the web page associated with the tab 110 includes a text summary of the associated web page. More specially, the visual tip 202 includes a list of headlines for the news presented in the associated web page “CNN.com.” Referring to FIG. 1B, which shows the web page associated with the visual tip 202, the headlines are consistent with the text summary in the visual tip 202.

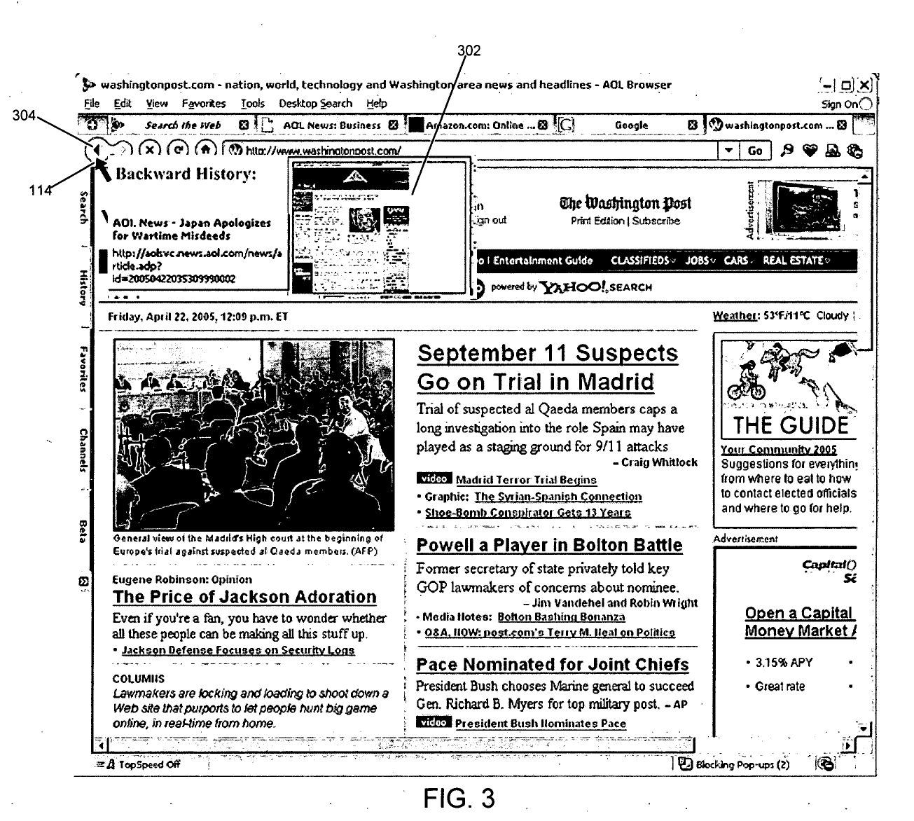

FIGS. 3-5 are exemplary screen shots of other examples of the visual tips displayed in the enhanced browser. In FIG. 3, an exemplary screen shot of the enhanced browser displays a visual tip 302 when the input pointer 114 hovers over a back button 304. The back button 304 is an example of a navigation control in the web browser that, when selected, navigates to a web page that the user previously visited. The visual tip 302 displays a miniature graphical representation of the web page that the user previously visited. The visual tip 302 may also display, for example, a title and/or a URL of the associated web page.

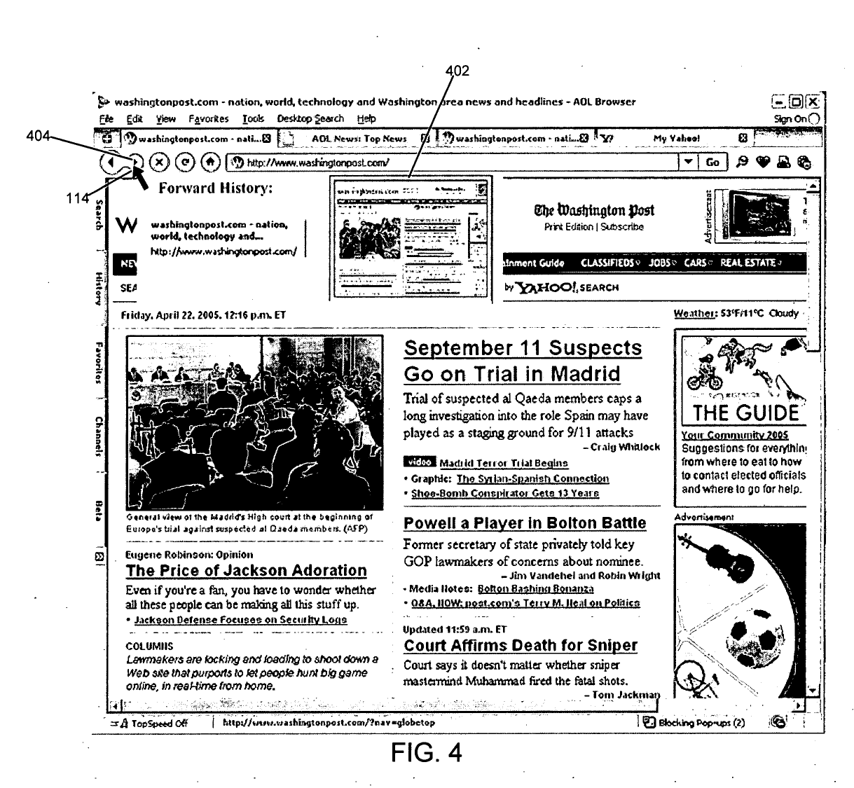

FIG. 4 is an exemplary screen shot of the enhanced browser showing a visual tip 402 when the input pointer 114 hovers over a forward button 404. The forward button 404 is another example of a navigation control in the web browser that, when selected, causes the browser to navigate to the next web page after the current web page in a history of web pages that were visited.

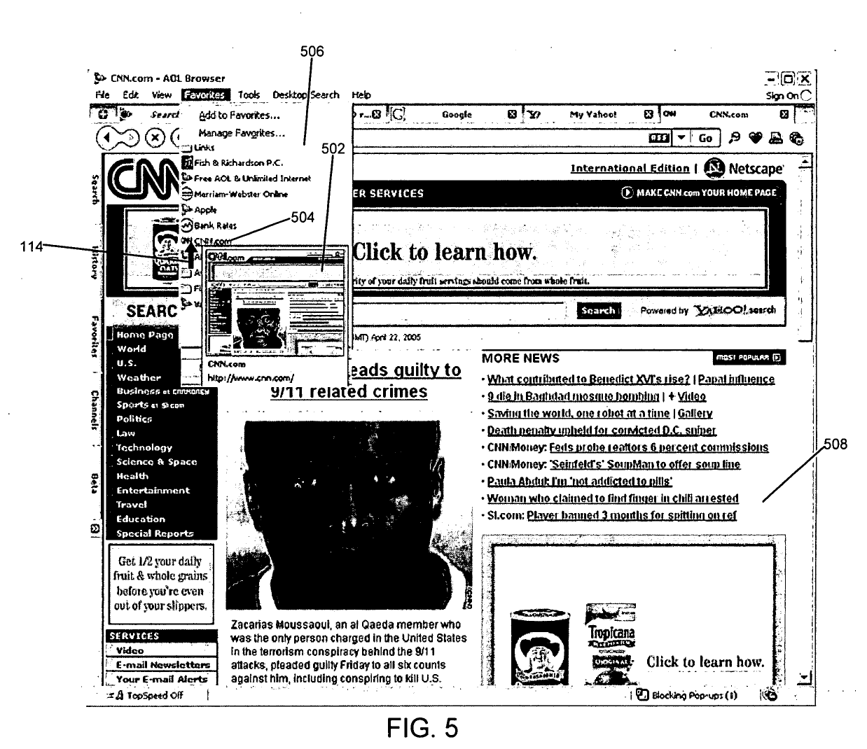

FIG. 5 is an exemplary screen shot of the enhanced browser showing a visual tip 502 when the pointer 114 hovers over an entry 504 in a “favorites” dropdown list 506. The “favorites” list 506 may include, for example, a list of web pages that the user frequently visits or in which the user is interested. The “favorites” list 506 also may serve as a navigation control for the browser user to organize and navigate the web pages. The browser user may pre-select an entry 504 from the favorites list 506 by hovering the pointer 114 over the entry 504 for a short period of time. The browser may then display the visual tip 502 for the pre-selected entry 504. In this example, the visual tip 502 includes a miniature graphical representation of the web page, “CNN.com.” The visual tip 502 also includes some other information regarding the web page, such as, for example, a title and/or a URL of the web page.

The browser user may, for example, further load the web page into the browser by clicking on the pre-selected entry 504. As a result, the associated web page, “CNN.com,” loads into the browser's content window 508. The loaded web page in the content window 508 has a similar look and feel to the miniature graphical representation shown in visual tip 502. As a result, when the visual tip 502 is displayed again later, the browser user may be reminded of the content of the web page based on the similarity.

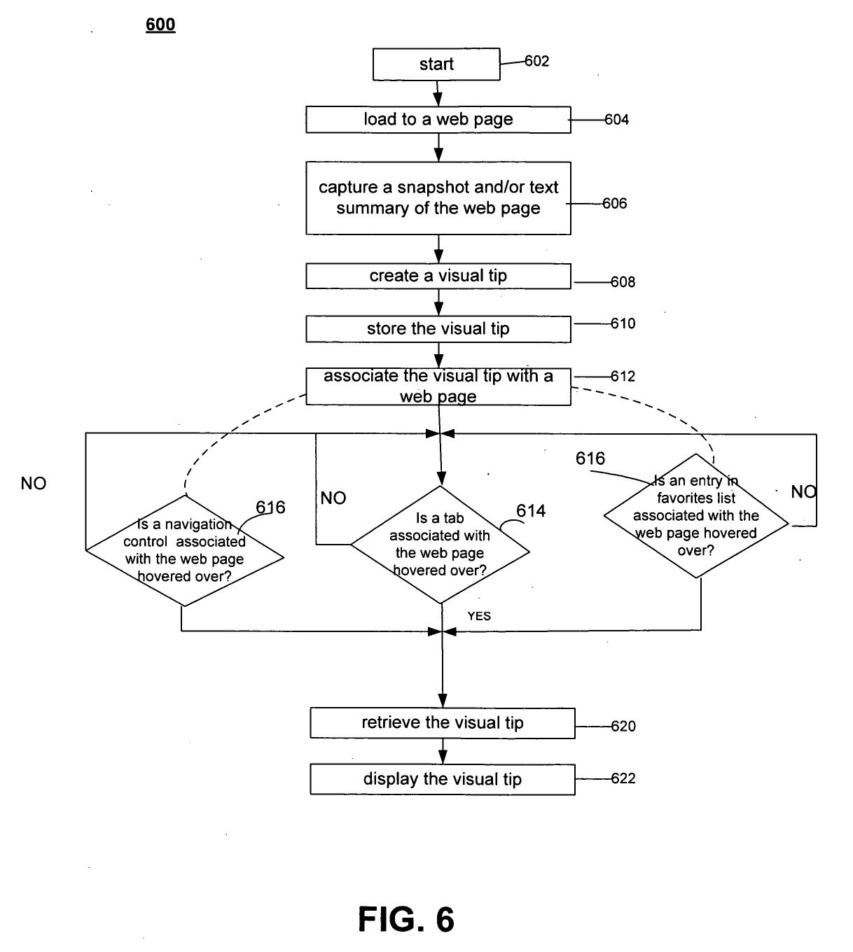

FIG. 6 is a flowchart illustrating an exemplary process 600 for creating, storing and retrieving visual tips from an enhanced browser. In one implementation, the enhanced browser application creates and stores the visual tips locally in the client system. The browser application may create visual tips for a number of links that the browser user visits. For example, the browser application may create a visual tip each time the browser visits a new link until, for example, a certain number or a storage size limit for visual tips is reached. The browser application also may update a visual tip when the browser revisits the associated link. In the above examples, the visual tips are created when the browser loads a web page of the associated link. As a result, the visual tips are consistent with the web pages that were loaded to the browser application earlier.

In another implementation, the visual tips are created and stored in a remote host code segment for the enhanced browser. The host system may create visual tips for a number of links that the browser user might visit. The host system updates the visual tips periodically such that the visual tips represent current, or relatively current, content of the web pages. For example, the browser application may obtain a miniature graphic representation of the web page, or a text summary of the web page, without loading the web page to the browser window. The browser application constructs and updates the visual tips automatically.

Regardless of whether the visual tips are created and stored in a local client system or a remote host system, the process 600 for creating, storing and retrieving visual tips may be performed. The process 600 may be executed by a computer program, or a service that is implemented to create and manage the visual tips. The process 600 may be executed on the client system, for example, as an integrated part of the browser application. The process 600 also may be executed on a remote server of the host system that manages the visual tips, and renders the visual tips to the client system using a communication network.

In one implementation, the process 600 starts when the browser application loads a web page (604) for the user to view. In another implementation, the process 600 starts when the host system initiates the process 600 to update the visual tips, such as, for example, based on a periodic schedule. The host system may load an updated web page to update the associated visual tip. Next, a snapshot and/or a text summary of the web page is captured (606). The snapshot of the web page may be saved as an image file, and the textual information of the web page may be saved in another file.

Next, a visual tip is created using the snapshot and/or text information (608). In one example, the snapshot of the web page may be resized to create a miniature representation of the web page. Text information, such as, for example, the title and/or the link information, may be attached to the visual tip. Additionally or alternatively, the textual information may be reformatted to create a presentable text summary of the web page. For example, textual information from a RSS feed may be reformatted from a XML format to a presentable HTML format that may be used in the display of the text summary in the visual tip.

The visual tip then is stored (610) in a storage, such as, for example, a local cache, a memory location, a hard disk, or a data base.

The host computer and/or the storage device may impose a size limit on the stored visual tips. For example, the host computer may limit the visual tips storage to be below 200 MB. The process 600 may further include a sub process to manage and maintain the stored visual tips. For example, old visual tips or infrequently used visual tips may be removed to make room for the newly created visual tips. In another example, the process 600 may involve moving the infrequently used visual tips from the cache to an external storage device, such as, an extra hard disk or a storage device, so that these visual tips may be swapped into the cache when requested.

The process also includes associating the visual tip with the web page (612). In one example, a look-up table is used to associate the web page with the visual tips. The reference to the web pages may be the keys in the look- up table that are used to obtain the references to the associated visual tips.

The process 600 also includes accepting requests at run time to retrieve a visual tip associated with a web page. In one example, a request for the visual tip is made when the pointer hovers over a tab associated with the web page (614). In another example, a request for the visual tip is made when the pointer hovers over a navigation control, such as, a forward button or a backward button, associated with the web page (616), as illustrated in FIGS. 3 and 4. In yet another example, the request is made when the pointer hovers over an entry in the favorites list associated with the web page (618), as illustrated in FIG. 5.

Upon receipt of the visual tip request, the visual tip is retrieved (620). For example, the reference to the associated visual tip may be obtained from the storage device, such as by retrieving a visual tip from the local cache and rendering it directly to the browser application. In another example, the visual tip is retrieved from the remote storage of the host system and passed to the browser application through the delivery network. Finally, the visual tip is displayed (622) in the enhanced browser.

FIG. 7 is a block diagram of a web communication system 700, where the web client 702 generates and stores visual tips. Referring to FIG. 7, a web communications system 700 is capable of delivering and exchanging data between web clients 702 and a web host 704 through a communications network 706. One web client 702 is shown in FIG. 7, but a number of web clients 702 may be present and may communicate with the web host 704. The web client 702 may be a general purpose computer, a special-purpose computer, a laptop, a PDA, or virtually any wired or wireless computing device that is capable of running a browser application.

The web host 704 provides resources, such as, for example, web pages, to the web clients 702. The web host 704 may include one or more general-purpose computers (e.g., personal computers), one or more special-purpose computers (e.g., devices specifically programmed to communicate with each other and/or the web clients 702), or a combination of one or more general-purpose computers and one or more special-purpose computers.

The web clients 702 connect to the web host 704 via a wired or wireless network 706. Examples of the network 706 include the Internet, the World Wide Web, WANs, LANs, analog or digital wired and wireless telephone networks (e.g., PSTN, ISDN, and xDSL), radio, television, cable, satellite, and/ or any other delivery mechanism for carrying data.

Referring to FIG. 7, the web client 702 includes a browser application 708 that communicates with the web host 704 to obtain web pages. The web client also includes a visual tip generator 710 that may generate a visual tip for a certain web page, as shown in step 608 of FIG. 6. For example, the visual tip generator 710 may capture a snapshot of a web page that is loaded into the browser 708 and may resize the snapshot to generate a miniature representation of the web page. The visual tip generator 710 also may obtain and transform a text summary of the web page into a presentable format. Additionally or alternatively, the visual tip generator 710 may combine the miniature graphical representation of the web page and the text information to create a well-formed visual tip.

The web client 702 also includes a visual tip storage 712 that saves the visual tips, such as, for example, as shown in step 610 of FIG. 6. The visual tip storage 712 may include a local cache of the web client machine that provides quick access for the browser application to retrieve visual tips. The visual tip storage 712 may also include memory, hard disk, CD-ROM or a storage device. A visual tip may be stored, for example, with a reference to the web page that the visual tip represents. A visual tip also may be retrieved by the reference to the web page.

Additionally or alternatively, the visual tip storage 712 may manage the visual tips such that the stored visual tips do not exceed a storage size limit. Upon reaching the size limit, the visual tip storage 712 may purge old or infrequently used visual tips to make room for newly created visual tips. In another example, the visual tip storage 712 may swap the excess visual tips to external storage devices.

Each web client 702 has its own visual tip storage 702. The visual tips were generated by the list of web pages that the web client 702 visited, and are specific to the browsing history of each web client machine 702. For the same web page, different web clients may present different visual tips because the visual tips may be generated at different times (i.e., at the times when the web page is last loaded by each web client 702).

FIG. 8 is a block diagram of a web communication system 800 in which a web host 802 generates and stores visual tips. Similar to the web communication system 700 in FIG. 7, the web communication t 800 is capable of delivering and exchanging data between web clients 802 and a web host 804 through a communications network 806. One web client 802 is shown in FIG. 8, but a number of web clients 802 may be present and may communicate with the web host 804. The web client 802 may be a general purpose computer, a special-purpose computer, a laptop, a PDA, or virtually any wired or wireless computing device that is capable of running a browser application.

The web host 804 provides resources, such as, web pages, to the web clients 802. The web host 804 may include one or more general-purpose computers (e.g., personal computers), one or more special-purpose computers (e.g., devices specifically programmed to communicate with each other and/or the web clients 802), or a combination of one or more general-purpose computers and one or more special-purpose computers.

The web clients 802 connects to the web host 804 via a wired or wireless network 806. Examples of the network 806 include the Internet, the World Wide Web, WANs, LANs, analog or digital wired and wireless telephone networks (e.g., PSTN, ISDN, and xDSL), radio, television, cable, satellite, and/ or any other delivery mechanism for carrying data.

Referring to FIG. 8, the web client 802 includes a browser application 808 that obtains web pages from the web host 804 and displays the web pages to the web user. The browser 808 also may display a visual tip for a web page before loading the web page. The browser 808 may obtain the visual tips for web pages from the web host 804 via the network 804.

The web host 804 provides web pages to a number of web clients 802. Additionally, the web host 804 generates, stores and manages the visual tips for a large number of web pages. The visual tips are shared by all the web clients 802. In one example, the web host 804 maintains visual tips for a pre-defined list of web pages. In another example, the web host 804 generates a visual tip for each web page that is requested by the web client 802.

The web host 804 includes a visual tip generator 810 that generates visual tips for web pages. In one example, the visual tip generator 810 loads the targeted web page and creates a miniature graphical representation or text summary of the web page. In another example, the visual tip generator 810 intercepts the web pages that are to be sent to the web client 802 to create the web page's miniature graphical representation or a text summary.

The web client 802 also includes a visual tip storage 812 that saves the visual tips. For example, the visual tip storage 812 may include memory, hard disk, CD-ROM, a database or virtually any storage device that is accessible to the web host 804. The visual tips may be stored, for example, with references to the web pages that the visual tips represent. The visual tips also may be retrieved by the reference to the web page.

The web client 802 also includes a visual tip updater 814 that updates the visual tips. For example, the visual tip updater 814 may update all of the visual tips according to a predefined schedule. The visual tip updater 814 also may update frequently used visual tips regularly, and may do so by updating a visual tip each time that a web client 802 requests an associated web page.

In this implementation, as shown in FIG. 8, the visual tips are shared among many web clients 802, which may relieve the burden on the web clients 802 with respect to processing and storing the visual tips. Frequent updates of the visual tips in the web host 804 also enable the web client 802 to receive updated visual tips without loading the updated web page.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method for rendering a graphical representation of a web page in a browser application, the method comprising:
loading a web page;
generating a graphical representation of the web page;
creating a visual tip using the graphical representation of the web page;
storing the visual tip;
associating the stored visual tip with a tab in a browser application; and
displaying the visual tip in the browser application when a pointer hovers over the tab associated with the web page.

2. The method of claim 1 wherein the visual tip comprises a miniature graphical representation of the web page.

3. A method for web navigating, the method comprising:
accessing one or more web pages;
associating each web page with a tab;
presenting each web page with an associated tab in a browser window;
detecting a pointer on a webpage, determining the pointer is hovering over a tab; and
displaying a visual tip of the web page associated with the tab based on the determination that the pointer is hovering over the tab.

4. The method of claim 3 wherein the visual tip includes a text summary of the associated web page.

5. The method of claim 3 wherein the visual tip includes a miniature graphical representation of the associated web page.

6. The method of claim 5 further comprising storing the miniature graphical representation of the web page in a local cache.

7. The method of claim 5 further comprising storing the miniature graphical representation of the web in a remote storage device.

8. A method for web navigating, the method comprising:
accessing one or more web pages;
associating each navigation control with a web page;
detecting a pointer on a webpage, determining the pointer is hovering over a navigation control; and
displaying a visual tip of the web page associated with the navigation control based on the determination that the pointer is hovering over the navigation control.

9. The method of claim 8 wherein the navigation control is a back button.

10. The method of claim 8 wherein the navigation control is a forward button.

11. The method of claim 8 wherein the navigation control is a favorite list.

12. An apparatus for web navigating, the apparatus being configured to:
access one or more web pages;
associate each web page with a tab;
present each web page with an associated tab in a browser window;
detect a pointer on a webpage, determine the pointer is hovering over a tab; and
display a visual tip of the web page associated with the tab based on the determination that the pointer is hovering over the tab.

13. The apparatus of claim 12 wherein the visual tip includes a text summary of the associated web page.

14. The apparatus of claim 12 wherein the visual tip includes a miniature graphical representation of the associated web page.

15. The apparatus of claim 14 further configured to store the miniature graphical representation of the web page in a local cache.

16. The apparatus of claim 14 further configured to store the miniature graphical representation of the web in a remote storage device.

17. An apparatus for web navigating, the apparatus being configured to:
access one or more web pages;
associate each navigation control with a web page;
detect a pointer on a webpage, determine the pointer is hovering over a navigation control; and
display a visual tip of the web page associated with the navigation control based on the determination that the pointer is hovering over the navigation control.

18. The apparatus of claim 17 wherein the navigation control is a back button.

19. The apparatus of claim 17 wherein the navigation control is a forward button.

20. The apparatus of claim 17 wherein the navigation control is a favorite list.

21. A apparatus for rendering a graphical representation of a web page in a browser application, the apparatus being configured to:
load a web page;
generate a graphical representation of the web page and create a visual tip using the graphical representation of the web page;
store the visual tip;
associate the stored visual tip with a tab in a browser application; and
display the visual tip in the browser application when a pointer hovers over the tab associated with the web page.

22. The apparatus of claim 21 wherein the visual tip comprises a miniature graphical representation of the web page.

23. A computer program product that, when executed, generates a graphical user interface on a display device for using a computer to web navigate, the graphical user interface comprising:
a tabbed browsing display that accesses one or more web pages, with each web page being associated with a corresponding tab in a browser window; and
a visual tip display that displays a visual tip for a web page when a pointer hovers over a the tab associated with the web page.

24. The computer program product of claim 23 wherein the visual tip includes a text summary of the associated web page.

25. The computer program product of claim 23 wherein the visual tip includes a miniature graphical representation of the associated web page.

26. The computer program product of claim 25 further comprising a local cache that stores the miniature graphical representation of the web page.

27. The computer program product of claim 26 further comprising a remote storage device that stores the miniature graphical representation of the web.

28. A computer program product that, when executed, generates a graphical user interface on a display device for using a computer to web navigate, the graphical user interface comprising:
an enhanced browsing display that accesses one or more web pages, with each web page being associated with a navigation control in a browser window; and
a visual tip display that displays a visual tip for a web page when a pointer hovers over a navigation control associated with the web page.

29. The computer program product of claim 28 wherein the navigation control is a back button.

30. The computer program product of claim 28 wherein the navigation control is a forward button.

31. The computer program product of claim of claim 28 wherein the navigation control is a favorite list.

32. A computer program product that, when executed, renders a graphical representation of a web page in a browser application, the computer program being configured to:
load a web page;
generate a graphical representation of the web page and creating a visual tip using the graphical representation of the web page;
store the visual tip;
associate the stored visual tip with a tab in a browser application; and
display the visual tip in the browser application when a pointer hovers over the tab associated with the web page.

33. The computer program of claim 32 wherein the visual tip comprises a miniature graphical representation of the web page.
